(19) United States
(12) Patent Application Publication
(10) Pub. No.: US 2009/0083051 A1
(43) Pub. Date: Mar. 26, 2009

(54) Interactive Self-Contained Business Transaction Virtual Object Generation

(76) Inventors: Brian R. Bokor, Raleigh, NC (US); Andrew B. Smith, Morrisville, NC (US); Daniel E. House, Raleigh, NC (US); William B. Nicol, II, Durham, NC (US)

Correspondence Address: MOORE & VAN ALLEN, PLLC For IBM, P.O. Box 13706, Research Triangle Park, NC, 27709, US

(21) Appl. No.: 11/861,782

(22) Filed: Sep. 26, 2007

(51) Int. Cl. G06Q 30/00; G06F 17/30

(52) U.S. Cl. 705/1

(57) ABSTRACT

A method for generating a virtual object in a virtual environment that includes performing a business transaction in a virtual environment, completing the business transaction, and generating a virtual object responsive to the completing the business transaction. The virtual object contains information related to at least one of a product or a service related to the business transaction. The virtual object may be stored in a storage mechanism accessible by the virtual environment and/or accessible by a user or avatar. A visual representation of the virtual object may be generated from the completed business transaction.

### BACKGROUND OF THE INVENTION

The present invention is related to generation of business transaction information, and more specifically to generation of an interactive business transaction virtual object.

Currently in the business world, when a product or service is purchased, there is no good means of easily providing a purchaser with all information relevant to the purchase. For example, when a person buys a product in a store, they may get the product placed in a bag with a receipt of the transaction but with no other product related information available except what is on the product packaging or in the packaging. Further, when a person purchases a product online, the buyer may get shipped a product and have to print out the receipt, or possibly email the receipt to him. For any other product information the buyer has to search for it online somewhere or register to get the information. Moreover, currently there is no approach for performing business transactions in a virtual environment. In addition there is no way of creating virtual objects related to business transactions, or storing these objects in an inventory.

### BRIEF SUMMARY OF THE INVENTION

According to one aspect of the present invention, a method for generating a virtual object in a virtual environment includes performing a business transaction in a virtual environment, completing the business transaction, generating a virtual object responsive to the completing the business transaction, and generating a visual representation of the virtual object from the completed business transaction.

According to another aspect of the present invention, a method for a virtual object in a virtual environment includes performing a business transaction in a virtual environment, generating a virtual object responsive to the completing the business transaction, the virtual object containing information related to at least one of a product or a service related to the business transaction, storing the virtual object in at least one of the virtual environment or in a storage mechanism accessible within the virtual environment, and accessing the stored virtual object by a user.

According to another aspect of the present invention, a system for a virtual object in a virtual environment includes a server, one or more workstations, and a network interconnecting the server and the one or more workstations, wherein the server hosts a virtual environment allowing a user at the one or more workstations to perform a business transaction in the virtual environment, a virtual object being generated responsive to the completing the business transaction, the virtual object containing information related to at least one of a product or a service related to the business transaction, the virtual object being stored in at least one of the virtual environment or in a storage mechanism accessible within the virtual environment, the stored virtual object being accessible by the user.

According to a further aspect of the present invention, a computer program product comprises a computer useable medium having computer useable program code embodied therewith, the computer useable program code comprising computer useable program code configured to perform a business transaction in a virtual environment, computer useable program code configured to complete the business transaction, computer useable program code configured to generate a virtual object responsive to the completing the business transaction, and computer useable program code configured to generate a visual representation of the virtual object from the completed business transaction.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of system for generation of a virtual business object according to an example embodiment of the present invention;

FIG. 2 is a diagram of virtual environment for generation of a virtual business object according to an example embodiment of the present invention;

FIG. 3 is a diagram of an interactive virtual business object according to an example embodiment of the present invention;

FIG. 4 is a flowchart of a process for generating a virtual business object according to an example embodiment of the present invention; and

FIG. 5 is a flowchart of a process for updating and accessing a virtual business object according to an example embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention provide a mechanism for a user to have virtual business objects of purchased products or services and also allow the user to store these virtual business objects. Specifically, embodiments according to the present invention provide a self contained bundle of product and product transaction information stored as an encapsulated virtual object thus enhancing the capability of a virtual object to contain relevant product data. The virtual business object (VBO) may be dynamically built at transaction completion. For example, after a transaction has been completed, a user may be given a virtual business object containing multiple types of information about the product or service related to the business transaction. The virtual business object provides for two-way communication with a product/service provider for updating product information, manuals, warranties, shipping information, etc.

Embodiments according to the present invention provide more valuable and meaningful data about a product, a good, or service that a buyer may have just purchased, once a transaction completes, as well as a mechanism for encapsulated storage.

To help illustrate embodiments according to the present invention, a user purchasing a product will be used. However, embodiments according to the present invention are not limited to a purchased product but may include purchased services or anything else purchased by a user and still be within the scope of the present invention.

Embodiments according to the present invention provide a way for all of the current manual work of organizing purchased product related items such as receipts, warranty cards, manuals, etc. to be performed by providing this product information as a virtual object bundle. A virtual business object according to embodiments of the present invention may include an object of a visual representation of the exact product purchased as well as supporting associated objects such as, for example, objects related to a purchase receipt, manuals, warranties, shipping info, etc. All objects are encapsulated into the virtual business object and provide a service oriented architecture (SOA) style two-way communication for some objects such as, for example, those related to shipping notification support process, warranty notifications, upgrades, etc. This allows dynamic real-time updating of this product related information.

Moreover, embodiments according to the present invention are not limited to virtual product purchases but may be a applied to any good or service whether it is a physical item that will be shipped or virtual objects in a virtual world. It will give a greater commerce experience because it fills a void that is not currently available in the real world, or current web commerce.

Every endpoint to the virtual business object may be searchable, updatable, etc. For example, if a user ordered a product that is currently not available, but is on backorder, the user may still be presented with a virtual business object after purchase. As the product becomes available, shipping info, warranty, product number or serial number, and/or support related information may be updated as the product is being shipped to the user.

According to embodiments of the present invention, a created virtual object may also reside in the inventory of an avatar in a virtual world environment. This provides a user an easy and convenient method to quickly retrieve a list of purchased items through various filters available in virtual world technologies today such as Second Life. The virtual object may be stored in the virtual environment or in a storage mechanism that is accessible within a virtual environment (e.g., a storage device outside of the virtual environment space but that may be used within the virtual environment space).

Embodiments according to the present invention add functionality in a virtual world environment that enables a set of bundled and easily accessible information for a given product. For example, if a user purchased a DVD player from a virtual store such as Circuit City, they would receive a corresponding virtual object. This virtual object may contain a receipt, standard and extended warranties, dealer/seller, support contact information, as well as a visual representation of the real world DVD player. If there is an issue or question with the purchased item a consumer is able to quickly access all of the information pertinent to that DVD player in their inventory with quick access to warranty, dealer, and support contact information.

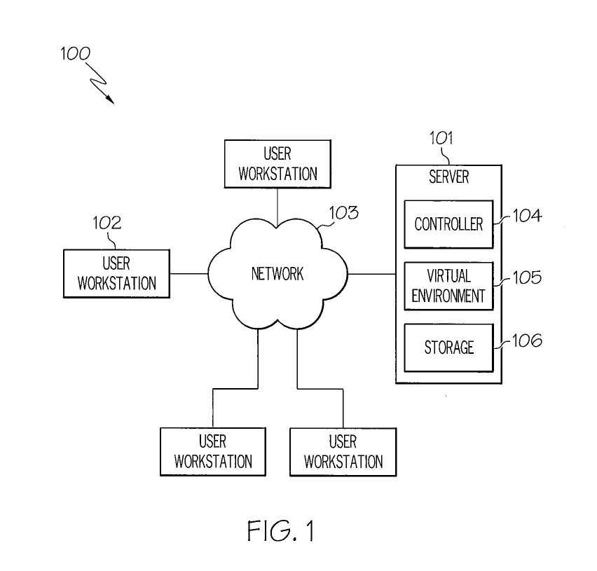

FIG. 1 shows a diagram of system for generation of a virtual business object according to an example embodiment of the present invention. The system 100 may include a server 101 and one or more workstations 102 where the server 101 and the one or more workstations 102 may be interconnected to a network 103. Although one server 101 is shown, there may be multiple servers connected to the network 103 and accessible by the one or more workstations 102. The server 101 may host the virtual environment 105 and also contain a controller 104 and storage 106. Therefore, a buyer at a workstation 102 may access the virtual environment 105 hosted on the server 101 and control an avatar in the virtual environment 105 to buy products or make other purchases or business transactions with a person, store, vendor, manufacturer, supplier, etc., which may also access the virtual environment and provide the products or services for sale in the virtual environment. The supplier of the product or services may also access the virtual world or environment 105 hosted on the server 101 via one or more workstations 102. Further, the processes/policies may be supplied by a supplier of the product, a vendor, a retailer, or a manufacturer upon completion of the transaction and generation of the virtual business object (VBO).

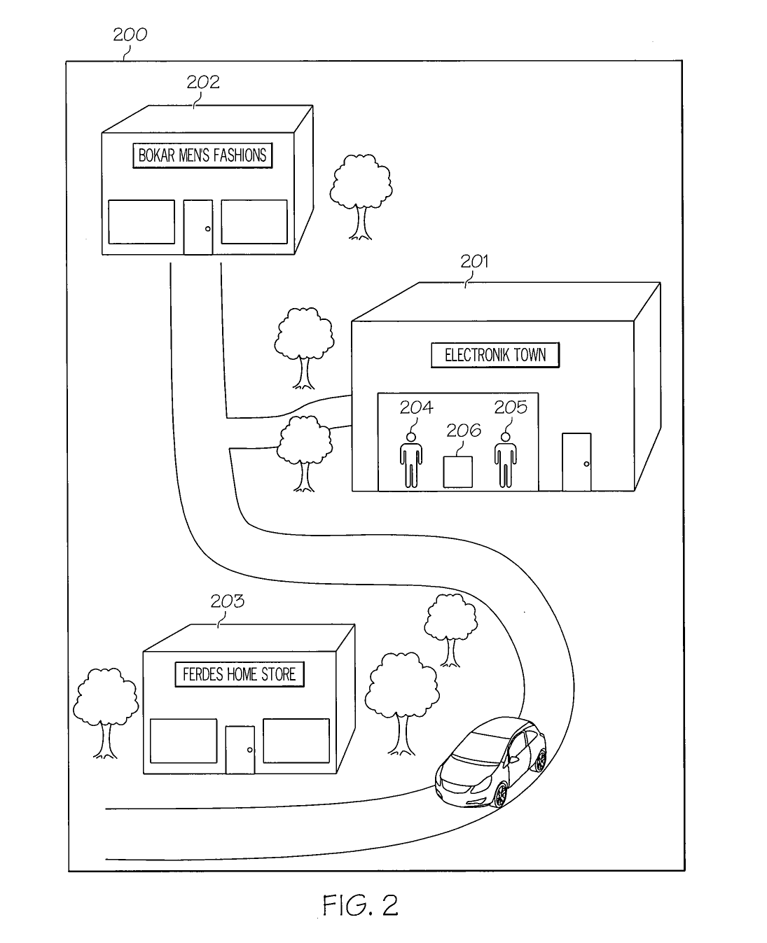

FIG. 2 shows a diagram of virtual environment for generation of a virtual business object according to an example embodiment of the present invention. In the virtual environment/world 200 there may exist an environment containing buildings, stores, trees, cars, people (represented by avatars) and any other items that currently exist in the real world. For example, a virtual world may contain virtual businesses or stores 201, 202, 203 that allow an avatar buyer to purchase products or services from an avatar seller. The avatar seller may be an individual or a business. Thus, the avatar buyer may enter into avatar (buyer) to avatar (seller) transactions or avatar (buyer) to Virtual On-line businesses transactions. In this example embodiment, an avatar buyer 204 in a virtual business “Electronik Town” 201 is purchasing a product 206 from an avatar 205 at the virtual online business “Electronik Town” 201. Upon completion of this transaction, a virtual business object may be generated and various policies/processes supplied by the avatar seller 205/virtual online business, or other sources, that may be encapsulated into the virtual business object. A visual representation of the virtual object may be generated from the completed business transaction, (e.g., a picture or 3D view of a purchased product (e.g. an iPod)) to represent all of the encapsulated data for that VBO.

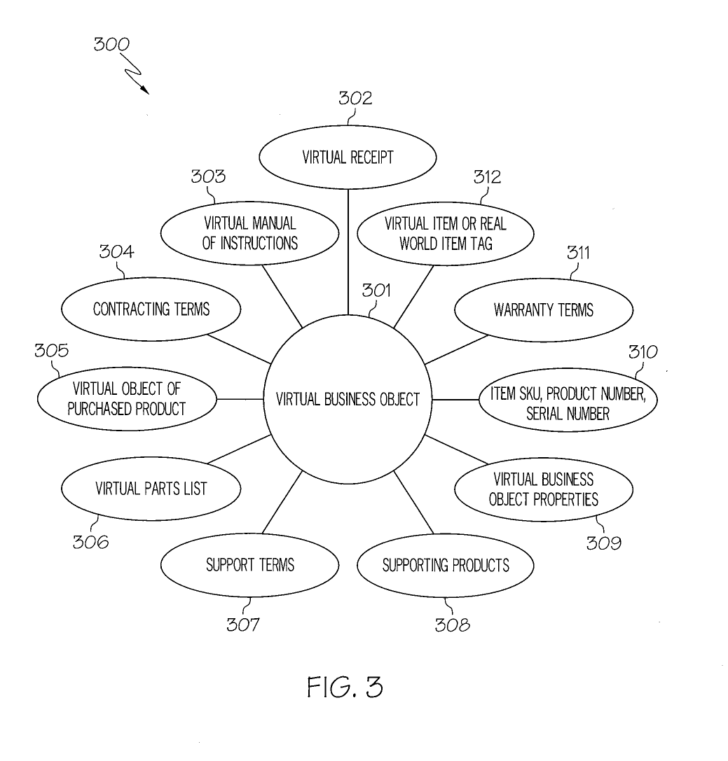

FIG. 3 shows a diagram of an interactive virtual business object according to an example embodiment of the present invention. The interactive virtual business object 300 may be generated upon completion of a business transaction between an avatar buyer and an avatar seller in a virtual environment, the transaction related to a product or service. The avatar seller may be an individual or a business. As noted previously, there may be to be avatar to avatar transactions or avatar to Virtual On-line businesses transactions. The interactive virtual business object 300 may include various information or other items associated with the business transaction related to the product or service. For example, the virtual business object 300 may include a virtual receipt 302, a virtual manual of instructions 303 related to the product or service, virtual contracting terms 304 associated with the business transaction, a virtual object of the purchased product 305, a virtual parts list 306 associated with the purchased product, support terms 307 related to the level of and possible duration of support provided for the purchased product or service, supporting products 308 related to the purchased product or service, properties 309 related to the virtual business object 300, a purchased stock keeping unit (SKU) and/or product number or serial number 310, virtual warranty terms 311 associated with the purchased product or service, or a virtual item or real world item tag 312 associated with the purchased product.

The avatar buyer of the product or service may have access to this information at anytime by accessing the virtual business object 300, which may be stored in the virtual environment or inventory mechanism or other data sources. Further, portions of the virtual business object 300 may be dynamically updated by the avatar seller or other appropriate entity (e.g., vendor, manufacturer, etc.) to keep the information current. For example, a supplier of a purchased product may decide to extend an issued warranty whereby the warranty terms 311 may be updated with modified warranty dates. Further, an entity that supports the purchased product or service may change addresses or the entity may transfer responsibility to a new entirely different entity and, therefore, the support terms 307 may be updated with this new information. In addition, new supporting products 308 may be identified related to the purchased product after creation of the virtual business object 300 and, therefore, the supporting products 308 portion of the virtual business object 300 may be updated. Any other appropriate information in the virtual business object 300 may also be dynamically changed or updated. Therefore, when a user (e.g., avatar buyer) decides to access the virtual business object 300 to obtain information, the user always receives the most updated information related to the information sought. In other embodiments of the present invention, the virtual business object may not be updated unless initiated by an avatar user.

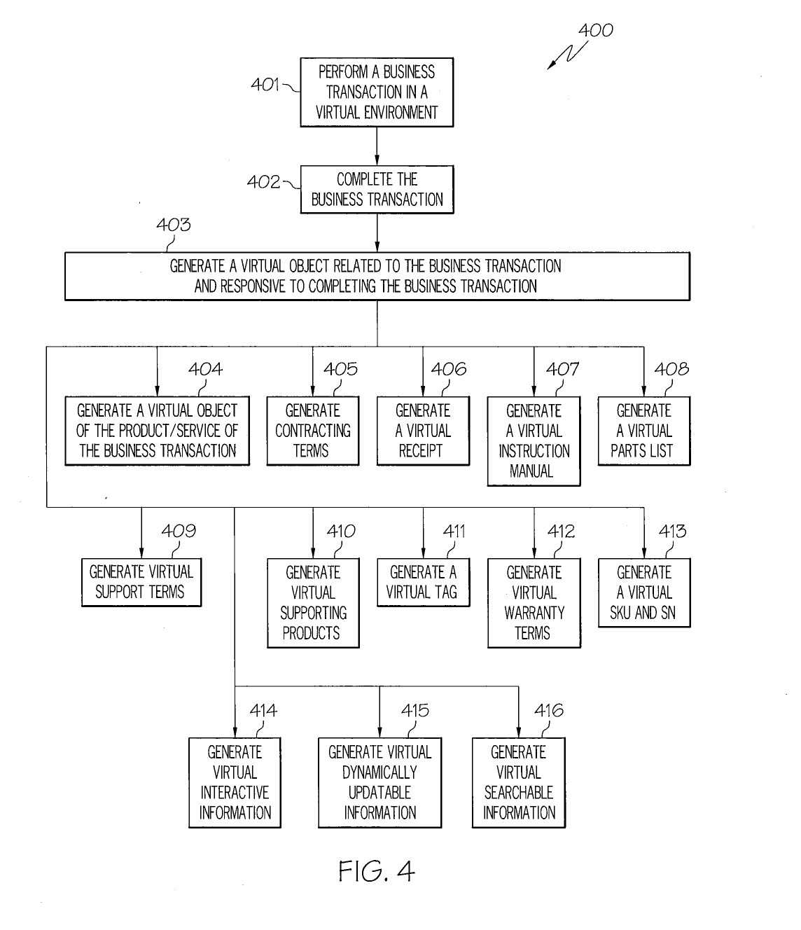

FIG. 4 shows a flowchart of a process for generating a virtual business object according to an example embodiment of the present invention. In the process 400, in block 401, a business transaction may be performed in a virtual environment. In block 402, the business transaction is completed. The business transaction may include a product or service being purchased by an avatar buyer. The completed business transaction may include an avatar buyer accepting terms of the business transaction and/or paying for a product or service related to the business transaction with an avatar seller. The avatar seller may be an individual or a business.

In block 403, a virtual object related to the business transaction may be generated in response to the completing of the business transaction. In this regard, when the virtual object is generated, a virtual object of the product/service of the business transaction may be generated 404, information related to contracting terms related to the business transaction 405 may be generated, information related to a virtual receipt 406 may be generated, information related to a virtual instruction manual 407 may be generated, information related to a virtual parts list 408 may be generated, information related to virtual support terms 409 may be generated, information related to virtual supporting products 410 may be generated, information related to a virtual tag 411 may be generated, information related to virtual warranty terms 412 may be generated. Further, of all the information generated when the virtual object is generated, some of the information may be generated to be virtually interactive 414, generated where it is virtual dynamically updatable 415, and/or generated such that the virtual information is searchable 416. Thus, some information in the virtual business object may be interactive with the avatar user. Further, information in the virtual business object may be dynamically updated therefore allowing an avatar user accessing the virtual business object to get the latest information. In addition, the virtual business object may provide the capability for an avatar user to enter search terms to allow the user to find information in the virtual business object.

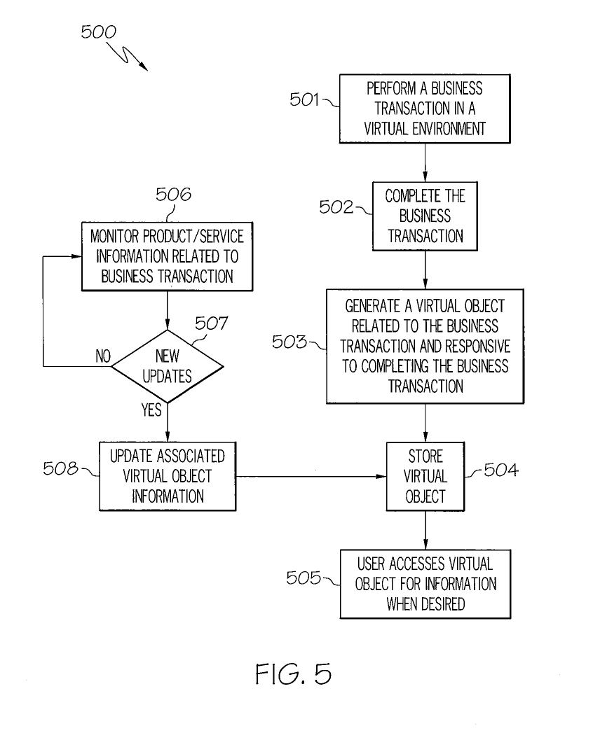

FIG. 5 shows a flowchart of a process for updating and accessing a virtual business object according to an example embodiment of the present invention. In the process 500, in block 501, a business transaction between an avatar buyer and an avatar seller may be performed in a virtual environment. In block 502, the business transaction may be completed. In block 503, a virtual object may be generated related the business transaction and in response to the completing of the business transaction. In block 504, the virtual object may be stored. In block 505, an avatar user or buyer involved in the business transaction may access the virtual object for information related to the completed business transaction, when desired.

Further, in block 506, an avatar seller or other entity may monitor information related to the product or service. In block 507, it may be determined whether there are new updates for any of the information in the virtual object, and if not, in block 506, the monitoring may continue. If there are new updates for any of the information in the virtual business object, in block 508, the associated information may be automatically updated.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for generating a virtual object in a virtual environment comprising:
performing a business transaction in a virtual environment;
completing the business transaction;
generating a virtual object responsive to the completing the business transaction; and
generating a visual representation of the virtual object from the completed business transaction.

2. The method according to claim 1, further comprising generating the virtual object containing information related to at least one of a product or a service related to the business transaction.

3. The method according to claim 2, further comprising generating a virtual receipt.

4. The method according to claim 2, further comprising generating a virtual instruction manual.

5. The method according to claim 2, further comprising generating a virtual contracting terms.

6. The method according to claim 2, further comprising generating a virtual object of at least one of a product or a service.

7. The method according to claim 2, further comprising generating a virtual parts list.

8. The method according to claim 2, further comprising generating virtual support terms.

9. The method according to claim 2, further comprising generating virtual supporting products.

10. The method according to claim 2, further comprising generating a virtual tag for the at least one of a product or a service.

11. The method according to claim 2, further comprising generating warranty terms.

12. The method according to claim 2, further comprising generating a stock keeping unit (Sku) and serial number for the at least one of a product or a service.

13. The method according to claim 2, further comprising generating the virtual object to include interactive information related to at least one of a product or a service related to the business transaction.

14. The method according to claim 2, further comprising generating the virtual object to include dynamically updatable information related to at least one of a product or a service related to the business transaction.

15. The method according to claim 2, further comprising generating the virtual object to contain searchable information related to at least one of a product or a service related to the business transaction.

16. The method according to claim 2, further comprising storing the virtual object in an inventory space of a user involved in the business transaction.

17. A method for a virtual object in a virtual environment comprising
performing a business transaction in a virtual environment;
generating a virtual object responsive to the completing the business transaction, the virtual object containing information related to at least one of a product or a service related to the business transaction;
storing the virtual object in at least one of the virtual environment or in a storage mechanism accessible within the virtual environment; and
accessing the stored virtual object by a user.

18. The method according to claim 17, further comprising accessing the virtual object by a user comprising a buyer involved in the business transaction.

19. The method according to claim 18, further comprising accessing interactive information in the virtual object related to the at least one of a product or a service by the buyer.

20. The method according to claim 18, further comprising accessing dynamically updatable information in the virtual object related to the at least one of a product or a service by the buyer.

21. The method according to claim 18, further comprising entering a search expression by the buyer to search for information in the virtual object related to the at least one of a product or a service.

22. The method according to claim 17, further comprising accessing the virtual object by a user comprising a seller involved in the business transaction.

23. The method according to claim 22, further comprising accessing the virtual object by the seller to dynamically update information in the virtual object related to the at least one of a product or a service.

24. The method according to claim 17, further comprising accessing the virtual object by a user comprising a vendor not involved in the business transaction, the vendor accessing the virtual object to dynamically update information in the virtual object related to the at least one of a product or a service.
